(19) United States
(12) Patent Application Publication
(10) Pub. No.: US 2007/0045235 A1
(43) Pub. Date: Mar. 1, 2007

(54) Electric switching device comprising an arc-quenching unit

(76) Inventor: Karsten Gerving, Bonn (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/575,922

(22) PCT Filed: Sep. 27, 2004
(86) PCT No.: PCT/EP04/52324

§ 371 Date: Apr. 14, 2006

(30) Foreign Application Priority Data
Oct. 18, 2003 (DE) 203 16 027.4

(51) Int. Cl. H01H 9/44

(52) U.S. Cl. 218/38

(57) ABSTRACT

An electric switching device, designed to carry a low-voltage, in particular a circuit-breaker or contactor, having at least one arc-quenching unit (16; 18) is provided. Connection contacts (8) are mounted in a housing (2) that can be sealed by a cover (4) and switching chambers (10) are configured in the housing. To adapt the device to different current ranges, the housing (2) and cover (4) are equipped with guide and retaining elements (12, 26, 28, 30) for cooling plates (16) that can be inserted and for arc-quenching laminated cores (18) that can be interchanged with the plates.

The present invention relates to an electrical switching device designed for low voltage, in particular a circuit-breaker or contactor, having at least one arc-quenching device, as set forth in the preamble of claim 1.

When switching devices interrupt high currents, in particular short-circuit currents, electric arcs form in the interrupting chambers thereof. In “Niederspannungs-Leistungsschalter [Low-Voltage Circuit-Breakers]”; Berlin, Heidelberg, New York 1979, pages 59 through 62, Franken describes the following methods for quenching electric arcs: extending the length of the arc, cooling the arc, and dividing the arc. In the arc-cooling method, the intensive cooling of the arc is essentially accomplished by contact with insulating parts or cooling plates. In the arc-division method, the electric arc is driven by magnetic forces into a system of arc splitter plates disposed in a parallel or curved arrangement, the arc being divided into several partial arcs, which results in a considerable increase in the voltage losses within the entire arc. In comparison with arc splitter plates, cooling plates are simpler and, therefore, less expensive to manufacture, but inferior in terms of the magnitude of the arc current to be extinguished.

DE 41 09 717 C1 discloses a contactor including an electromagnetic operating mechanism which is arranged in a multi-part housing, switching contacts which are accommodated in interrupting chamber, and further including arc splitter plates which are associated with the switching contacts and form extinguishing chambers, and which are accommodated in a top housing part which can be closed a cover. The arc splitter plates, which are assembled by means of insulating plates to form arc splitter plate stacks and are inserted into the housing chambers, are resiliently pressed and clamped against the wall of the top housing part by means of end legs of commutation plates, said end legs being bent in a double U-shape.

In a contactor according to DE 198 14 411 C1, the uppermost arc splitter plate, which faces the cover and is designed as a shield plate, each has two clips which are bent upward. Recesses corresponding to the clips are formed on the inner side of the cover. The extinguishing chambers can be fastened to the cover by inserting the clips in the recesses, forming a positive-locking joint.

The object of the present invention is to make switching devices suitable for switching operation in different current ranges using simple means.

Starting from a switching device of the type mentioned at the outset, this objective is achieved according to the present invention by the features of the independent claim while advantageous refinements of the invention will be apparent from the dependent claims.

The housing and the cover are provided with guide and retaining elements for both cooling plates and arc splitter plate stacks. Thus, switching devices which are otherwise identical in design can optionally be equipped with arc-quenching devices in the form of cooling plates or in the form of arc splitter plate stacks. When equipped with cooling plates, a less expensive switching device variant is obtained, whereas the variant equipped with arc splitter plate stacks provides a switching device having a higher switching capacity. Thus, the particular desired switching device variant can be produced with little effort while retaining the other component parts.

In an advantageous embodiment of the present invention, the arc splitter plates are guidingly secured in place by inner walls and formations of the housing and by first retaining elements of the cover which provide a hold-down effect. In another embodiment, the arc splitter plate stacks are secured in place by second retaining elements of the cover. In an advantageous embodiment, the guide and retaining elements for the cooling plates and those for the arc splitter plate stacks are arranged one behind the other; the guide and retaining elements for the cooling plates being closer to the switching contacts, while the guide and retaining elements for the arc splitter plate stacks are closer to the terminal contacts.

Further details and advantages of the present invention will become apparent from the exemplary embodiment described below with reference to the Figures, in which:

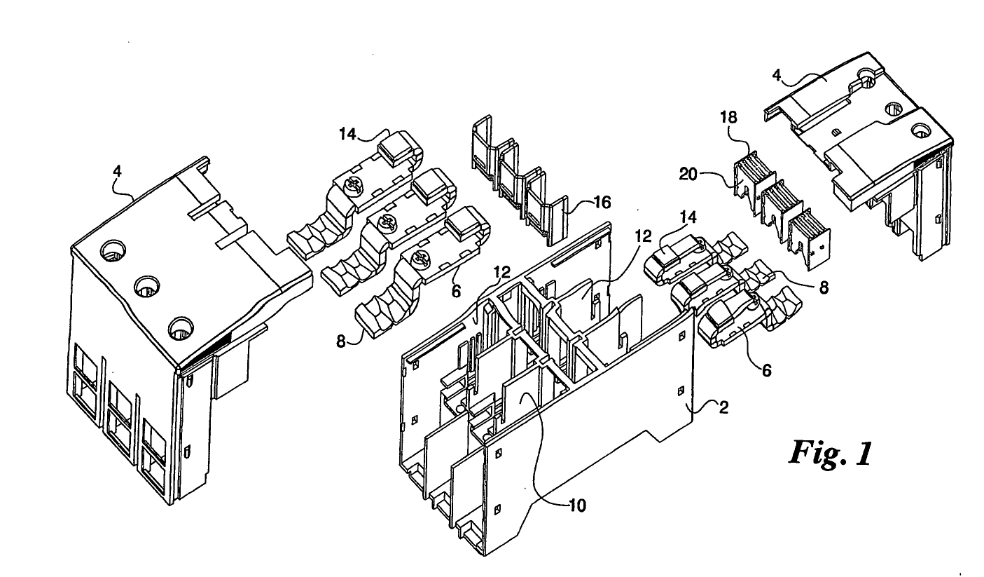

FIG. 1 is a perspective exploded view of the switching device of the present invention, including arc-quenching devices;

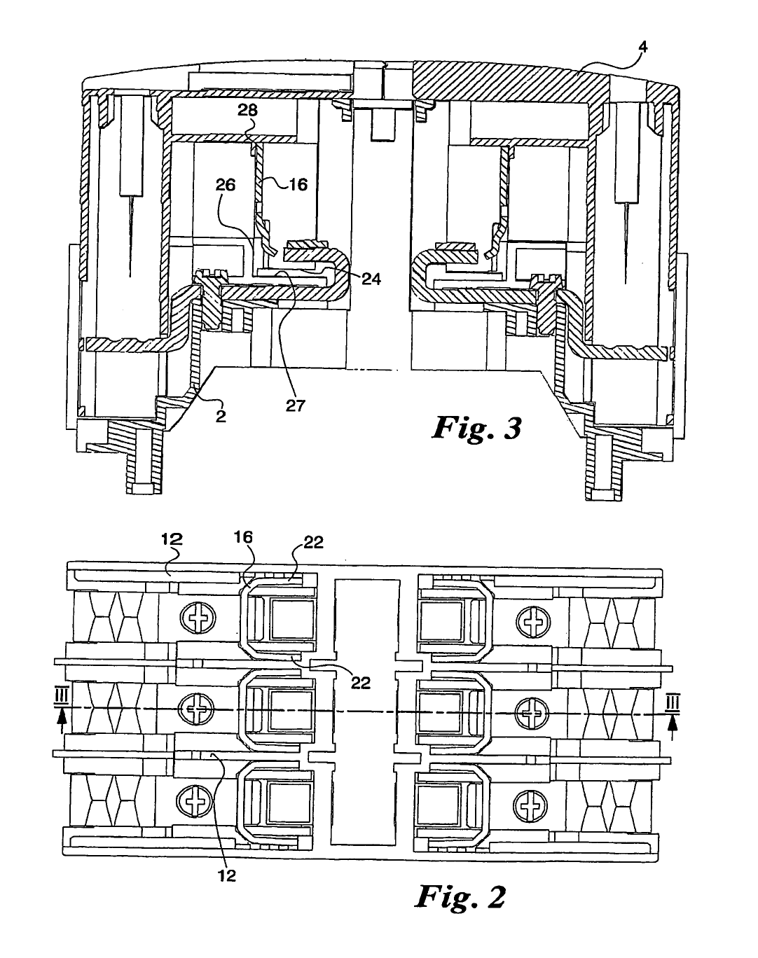

FIG. 2 is a top view of the open housing with the cooling plates inserted;

FIG. 3 shows longitudinal section III-III according to FIG. 2, with the cover mounted;

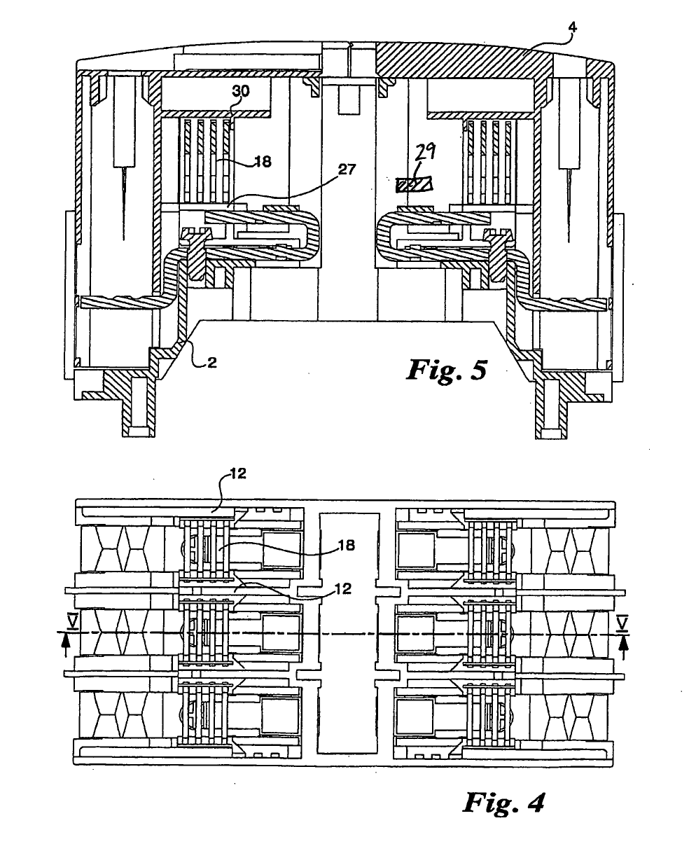

FIG. 4 is a top view of the open housing with the arc splitter plate stacks inserted;

FIG. 5 shows longitudinal section V-V according to FIG. 4, with the cover mounted.

FIG. 1 shows the top part of a multi-part housing 2 and a two-part cover 4, which closes the housing 2, of an electrical switching device, such as a three-pole contactor. For each pole, two contact straps 6 are secured in position in housing 2, said contact straps having externally accessible terminal contacts 8. Contact straps 6 extend into interrupting chambers 10, which are laterally bounded by inner walls 12 formed in housing 12. On the interrupting chamber side, contact straps 6 are provided with stationary switching contacts 14, which cooperate in a known manner with movable switching contacts (not shown) in the form of contact bridges. An arc-quenching device, either in the form of a U-shaped cooling plate 16 or in the form of an arc splitter plate stack 18 of spaced-apart stacked arc splitter plates 20, can be inserted into each interrupting chamber 10. To this end, guide and retaining elements are formed in housing 2 and in cover 4, said guide and retaining elements being described in more detail below. In each interrupting chamber 10, the mounting position of cooling plate 16 and the mounting position of arc splitter plate stack 18 extend one behind the other with respect to the longitudinal direction of the respective switch pole. In this connection, the mounting position of cooling plates 16 is closer to stationary switching contacts 14, while the mounting position of the arc splitter plate stacks 18 is closer to terminal contacts 8.

According to FIG. 2 and FIG. 3, cooling plates 16 are laterally guided, with their outer legs 22, by inner walls 12 and, with their end faces 24 that face away from cover 4, they are positioned in their proper locations in pocket-like formations 26 in bottom 27 of the shown housing part of housing 2. Formed on the inner side of cover 4 are first retaining elements 28, which hold down and lock cooling plates 16 in their mounting position, when cover 4 is mounted.

According to FIG. 4 and FIG. 5, arc splitter plate stacks 18 can be secured with one side in pocket-like second retaining elements 30 of cover 4, forming a frictional and/or form-locking connection. After placing cover 4 onto housing 2, arc splitter plate stacks 18 are locked in their mounting position between inner walls 12 as well as between bottom 27 of housing 2 and cover 4.

1-4. (canceled)

5. An electrical switching device comprising:
a housing having interrupting chambers;
a cover capable of closing the housing; and
externally accessible terminal contacts being secured in position in the housing;
each interrupting chamber having disposed therein at least one arc quenching device and a stationary switching contact for a cooperating movable switching contact,
the housing and the cover having formed therein guide and retaining elements for both insertable cooling plates and arc splitter plate stacks defining the arc quenching devices, the arc splitter stacks being interchangeable with the cooling plates.

6. The electrical switching device as recited in claim 5 wherein the guide and retaining elements include inner walls of the housing laterally bounding the interrupting chambers and first retaining elements of the cover, the cooling plates being U-shaped and having outer legs and being supported with the outer legs on the inner walls of the housing, the cooling plates having end faces facing away from the cover in pocket-like formations of the housing, the U-shaped cooling plates further being held down by the first retaining elements.

7. The electrical switching device as recited in claim 5 wherein the guide and retaining elements include inner walls of the housing laterally bounding the interrupting chambers and pocket-like second retaining elements of the cover, the arc splitter plate stacks being secured with one side in the pocket-like second retaining elements via a frictional and/or form-locking connection, and, when the cover is mounted, the arc splitter plate stacks being supported between the inner walls of the housing.

8. The electrical switching device as recited in claim 5 wherein the guide and retaining elements includes arc splitter guide and retaining elements and cooling plate guide and retaining elements, the arc splitter guide and retaining elements being adjacent to the guide and cooling plate retaining elements in a direction of the terminal contacts.

9. An electrical switching device comprising:
a housing having interrupting chambers and housing guide and retaining elements;
a cover capable of closing the housing and having cover guide and retaining elements; and
externally accessible terminal contacts being secured in position in the housing;
a stationary switching contact located in each interrupting chamber, the stationary switching contact cooperating with a movable switching contact; and
an arc quenching device located in each interrupting chamber, the arc quenching device being either an insertable cooling plate or an arc splitter stack, the housing guide and retaining elements and the cover guide and retaining elements including both cooling plate guide and retaining elements and arc splitter stack retaining elements.
